(19) United States
(12) Patent Application Publication
(10) Pub. No.: US 2005/0191082 A1
(43) Pub. Date: Sep. 1, 2005

(54) Image decolorizing apparatus

(76) Inventors: Satoshi Takayama, Kawasaki-shi (JP); Kenji Sano, Tokyo (JP); Takeshi Gotanda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/048,799

(22) Filed: Feb. 3, 2005

(30) Foreign Application Priority Data
Feb. 3, 2004 (JP) 2004-026980

(51) Int. Cl. G03G 15/16

(52) U.S. Cl. 399/101

(57) ABSTRACT

An image decolorizing apparatus decolorizing an image formed on a printed medium using a decolorable image forming material containing a color former, a developer, and a binder resin, has a scratching mechanism scratching the printed medium at a temperature lower than a softening temperature of the binder resin, and a heater heating a scratched surface of the printed medium to a temperature higher than the softening temperature of the binder resin.

### CROSS-REFERENCE TO RELATED APPLICATIONS

This application is based upon and claims the benefit of priority from prior Japanese Patent Application No. 2004-026980, filed Feb. 3, 2004, the entire contents of which are incorporated herein by reference.

### BACKGROUND OF THE INVENTION

1. Field of the Invention

The present invention relates to an apparatus that decolorizes an image formed using a decolorable image forming material containing a color former, a developer, and a binder resin.

2. Description of the Related Art

The recent spread of office automation is steadily increasing the amount of data contained in various pieces of information. Correspondingly, the amount of hard copy outputs, that is, the amount of information output by printers to paper is increasing year by year. However, at present, the protection of environments and wood resource saving is critical all over the world. Thus, it is very important to minimize the amount of hard copy outputs to save paper.

Various methods have been proposed for recycling paper in offices. These methods can be roughly classified into the following two types.
[1] The surface of a printed medium is scratched to scrape off an image forming material.
[2] The printed medium is heated to transfer the image forming material to other medium to peel it off.

A problem with the first method is that the image cannot be decolorized to a practical level. Moreover, the first method is disadvantageous in that if paper is polished until the quality of decolorizing reaches a practical level, it may be damaged. To eliminate this disadvantage, a method for applying an opaque paint to a polished surface (see Jpn. Pat. Appln. KOKAI Publication No. 6-255229) has been proposed. However, this method has not been put to practical use because it consumes the opaque paint, which is an expendable supply, and because it requires a considerable amount of time and energy for drying the paint.

To decolorize an image to a practical level using the second method, it is necessary to provide a mechanism which applies a surfactant to the surface of paper before thermal peeling and drying the printed medium after the image forming material has been peeled. Thus, this method disadvantageously requires the size of the apparatus to be increased. Therefore, this method is unsuitable for the recycling of paper in offices.

Another method has been proposed for using surface treated paper as printed media. However, this method makes it impossible to use plain paper.

Another technique for recycling hard copies is a method of using rewritable recording media. This medium is a thermal recording technique using special paper with its surface coated with an image forming material that is repeatedly colored and decolorized when heated. The rewritable recording medium has many excellent characteristics but has not come into wide use because only thermal recording is applicable to it and because it brings about a high expendable supply cost.

Moreover, a conventional technique for recycling hard copies uses decolorable inks (see, for example, Jpn. Pat. Appln. KOKAI Publication No. 5-297627). This technique recycles hard copies using the methods described below.
[1] Decolorizing toners or decolorizing heat-sensitive transfer media are used which contain a basic dye or dye precursor and an acidic organic compound and which is decolored when irradiated with light.
[2] Coloring and decolorizing toners are used which contain a lueco dye, an acidic organic compound, and a basic compound and which are colored when heated and then decolorized when further heated.
[3] Toners are used in which the surfaces of coloring grains are covered with a thermal reversible material which is changed between a transparent state and an opaque state when heated.
[4] An image forming material containing a dye or a developer having a sublimation property is used and heated to sublimate the dye or developer for decolorizing.
[5] Decolorizing toners or coloring and decoloring heat-sensitive transfer media are used which contain a lueco dye, an acidic organic compound, and a basic compound; when these toners or media are heated, the basic compound is melted to act on the lueco dye for decolorizing.

A problem with the first method is the lightfastness. Disadvantageously, even when a powerful light source is used in view of the lightfastness of an image, this method generally requires light irradiation for about several minutes. This method is very inconvenient particularly when the image is to be partly decolorized. A problem with the second method is that this composition system is essentially stable in a colorless state, so that the image gradually disappears over time. Further, this process requires heating and quenching for coloring. Consequently, this method disadvantageously lacks versatility. A problem with the third problem is that the rewritable marking material utilizing light scattering provides insufficient hiding ability for internal dyes. This method thus cannot recover printed media to their original white state. A problem with the fourth method is that the image is thermally unstable and is thus gradually decolored even at room temperature. Compared to these methods, a fifth method uses an image forming material with relatively excellent characteristics. This method is advantageous in that the image is stable and has a high contrast and that the time required for decolorizing can be reduced. However, with this method, after thermal decolorizing, the contents can be read owing to a difference in reflectance between the binder resin and the printed media. Thus, this method evidently lacks security.

As described above, the prior art has not sufficiently met the requirements for the recycling of paper and for security.

To solve the problems with the conventional recycling techniques, the inventors have studied decolorable image forming material for many years. The inventors have already developed decolorable image forming materials wherein when the image forming material is heated until a decolorizing agent present inside or outside the material is activated, a developer interacts with the decoloring agent to erase the color of a color former. However, disadvantageously, when an image formed using this image forming material is visually checked, a binder of the image forming material may remain as in the case of the above fifth method. As a result, the image expected to have been decolorized can be viewed as reflection on the surface of paper.

The inventors have proposed a method of reducing the level of reflection on the surface by using, for example, a polishing roller to provide roughness to the surface of the image forming material after thermal decolorizing and then causing surface scattering so that the reflection cannot be easily recognized (see Japanese Patent 3278626). This method makes it difficult to view the image after decolorizing but cannot make the image perfectly invisible. Of course, a main factor concerning this is a difference in reflectance between paper and the binder resin. However, as another factor, it has also been found that heating after the thermal decoloring causes the image forming material to firmly adhere to paper fibers and that the image forming material becomes so rigid that its surface cannot be easily roughened in spite of polishing.

The inventors have found that this problem results from the presence of an area on the surface which has a different reflectance and at least a certain size and that this area is invisible when its size is smaller than that mentioned above. Thus, the inventors have been able to propose a method for perfectly decolorizing the image. The method is to bring a solvent into contact with the image forming material for decolorizing. The solvent used tends to separate the dye from the developer and to swell or partly dissolve the binder resin. This method can provide a high-quality decolorized state because the organic solvent dissolves the binder resin to disperse the image forming material over a wide range including the interior of the paper fibers, thus preventing the decolored image forming material with an area as large as to be visually recognized from remaining on the surface of the paper. This is an effective decolorizing method which can make the image invisible. However, because of the use of the solvent, this method requires, for example, a safety device and a mechanism that recovers the solvent. This results in the increased size and cost of the apparatus. Therefore, this method cannot meet the user's need to use the apparatus as a shredder in an office.

### BRIEF SUMMARY OF THE INVENTION

According to an aspect of the present invention, there is provided an image decolorizing apparatus decolorizing an image formed on a printed medium using a decolorable image forming material containing a color former, a developer, and a binder resin, comprising: a scratch mechanism scratching the printed medium at a temperature lower than a softening temperature of the binder resin; and a heater heating a scratched surface of the printed medium to a temperature higher than the softening temperature of the binder resin.

### BRIEF DESCRIPTION OF THE SEVERAL VIEWS OF THE DRAWING

FIG. 1 is a graph showing the appropriate ranges of decoloring temperature and processing time;

FIG. 2 is a view showing the configuration of an image decoloring apparatus according to Example 1;

FIG. 3 is a view showing the configuration of an image decoloring apparatus according to Example 2;

FIG. 4 is a view showing the configuration of an image decoloring apparatus according to Example 3;

FIG. 5 is a view showing the configuration of an image decoloring apparatus according to Example 4;

FIG. 6 is a view showing the configuration of an image decoloring apparatus according to Example 5; and

FIG. 7 is a view showing the configuration of an image decolorizing apparatus according to Example 6.

### DETAILED DESCRIPTION OF THE INVENTION

An image decoloring apparatus according to embodiments of the present invention decolors an image to an invisible level, the image being formed using an image forming material containing a color former, a developer, and a binder resin. The image decolorizing apparatus has a scratching mechanism scratching a printed medium at a temperature lower than a softening temperature of the binder resin and a heater heating a scratched surface of the printed medium to a temperature higher than the softening temperature of the binder resin.

The scratching mechanism scratches the printed medium to remove at least a part of the image forming material. Specifically, a scratching medium constituting the scratching mechanism includes a gravure roll, a blade, a mesh, a file, a brush, or a cloth. In view of the balance between damage to the paper owing to the scratching and the capability of removing the image forming material, the scratching mechanism suitably has a surface roughness (grain size) of #240 or finer, more preferably between #400 and #1200. As a target for polishing, the difference in reflection density between the image portion and the printed medium itself after the scratching is at most 0.2, more preferably at most 0.1.

The heater heats the image forming material to a temperature exceeding the softening temperature of the binder resin. This reduces the level of the interaction between the color former and the developer to decolor the image. The heater is not particularly limited provided that it can heat the image forming material to a temperature exceeding the softening temperature of the binder resin. Specifically, the heater includes a warm air exhauster, an infrared-ray irradiation device, a heat roller, a hot press, a thermal printer head (TPH), a laser, or a thermal bar. The heating temperature and the time required for heating have appropriate ranges. The range of the heating temperature is determined depending on the time required for the printed medium to pass through a heating portion of the heater. As a specific example, FIG. 1 shows the appropriate ranges of decolorizing temperature and heating time for an image formed using toners containing a binder resin of styrene-butadiene co-polymer having a softening temperature of about 120° C. For a sheet-fed thermal decoloring apparatus, it is necessary to set the effective heating time to at most several seconds. Accordingly, the appropriate range of the heating temperature is at least 190° C. On the other hand, in view of the heat resistance of the image forming material, the upper limit temperature is desirably at least 225° C. Therefore, the recommended range of the thermal decoloring temperature and processing time is the area enclosed by a thick line in FIG. 1.

According to another embodiment of the present invention, the apparatus may be provided with a cleaner cleaning a scratched waste material adhering to the surface of the printed medium so as to maintain the roughness of the scratched surface and a collecting mechanism collecting the waste material, both mechanisms being arranged between the scratching mechanism and the heater. A specific cleaning device includes a blade, a brush, an air blow device, a vacuum suction device, an electrostatic suction device, an adhesive roller, a felt, or a cloth.

According to another embodiment of the present invention, the apparatus may be provided with a roughening mechanism roughening a printed surface of the printed medium after the heating. Specifically, similarly to the scratching mechanism, the roughening mechanism for the printed surface of the printed medium includes a gravure roll, a blade, a mesh, a file, or a brush. In view of damage to the paper owing to the polishing, a roughening surface suitably has a surface roughness (grain size) of #120 or finer, more preferably at least #240. A surface roughening step reduces the gloss of the surface of the printed medium caused by the scratching step. Further, by setting, for the roughening mechanism, a temperature range equal to or higher than the softening temperature of the image forming material, it is possible to reduce the effect of the image forming material remaining on the surface of the printed medium.

According to another embodiment of the present invention, the apparatus may be provided with a detector detecting a difference in reflection density between the image portion and the printed medium itself after scratching or the reflection density of the image portion after scratching and a controller controlling scratching conditions for the scratching mechanism.

Further, each mechanism described above may be provided in plural number, if desired.

### EXAMPLE 1

The apparatus according to the present example uses a scratching roll serving as a scratching mechanism and processed so as to have a surface roughness of #400 and a heat roll serving as a heater.

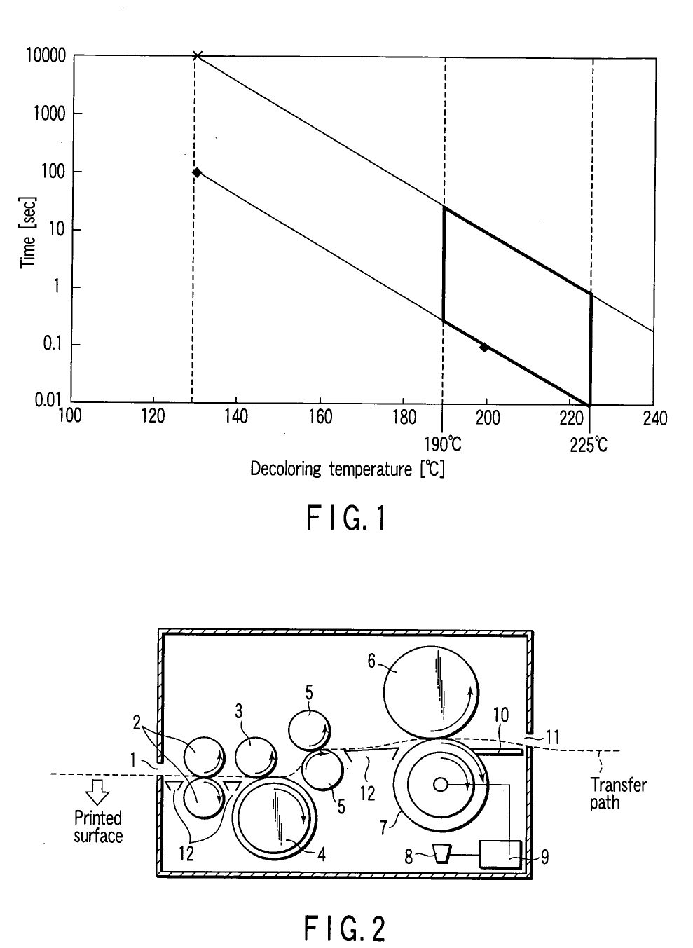

The apparatus according to the present example will be described with reference to FIG. 2. A printed medium is transferred at a fixed speed by the pair of transfer rolls 2 made of co-polymer and installed close to the input port 1. The scratching roll 4 is provided immediately after the first transfer rolls 2 and opposite the elastic roll 3. The printed surface of the printed medium is polished by the scratching roll 4 by which most image forming material is peeled off. The scratching roll 4 and the printed medium are driven at a relative speed of 25 mm/sec. The elastic roller 3 is freely rotatable. While no printed medium is sandwiched between the elastic roll 3 and the scratching roll 4, the elastic roll 3 rotates at the same speed as that of the scratching roll 4. This prevents the surface of the elastic roll 3 from being damaged by friction with the scratching roll.

The pair of second transfer rolls 5 is installed at an appropriate distance from the scratching roll 4. The transfer speed of the second transfer rolls 5 is set slightly higher than that of the first transfer rolls. This is to tension the printed medium on the basis of the difference in speed between the two pairs of transfer rolls.

The heat roll 7 is placed immediately after the second transfer rolls 5; the heat roller 7 is paired with an opposite roll 6 which is elastic and resistant to heat. The printed surface of the printed medium is heated by the heat roll 7 to a sufficient temperature. This serves to decolor a small amount of image forming material remaining from the scratching step and a small amount of image forming material peeled off and scattered to adhere to the printed medium. Consequently, the image becomes invisible. The noncontact temperature sensor 8 appropriately measures the surface temperature of the heat roll 7. The temperature controller 9 adjusts outputs to a heater to maintain the fixed surface temperature of the heat roll 7. The printed medium attached to the heat roller is released by the releaser 10 and discharged through the output port 11. The transfer guides 12 are installed in the path of the printed medium at appropriate positions.

The transfer mechanism for paper is mainly composed of the transfer rollers arranged in the paper transfer path to separate the interior from exterior of the apparatus and to separate the blocks of the apparatus from one another. The transfer rollers may be provided with a switching function for actuating and stopping the apparatus.

### EXAMPLE 2

The apparatus according to the present example uses a stainless mesh sheet of #300 as a scratching mechanism and a heat roll similar to that described in Example 1, as a heater.

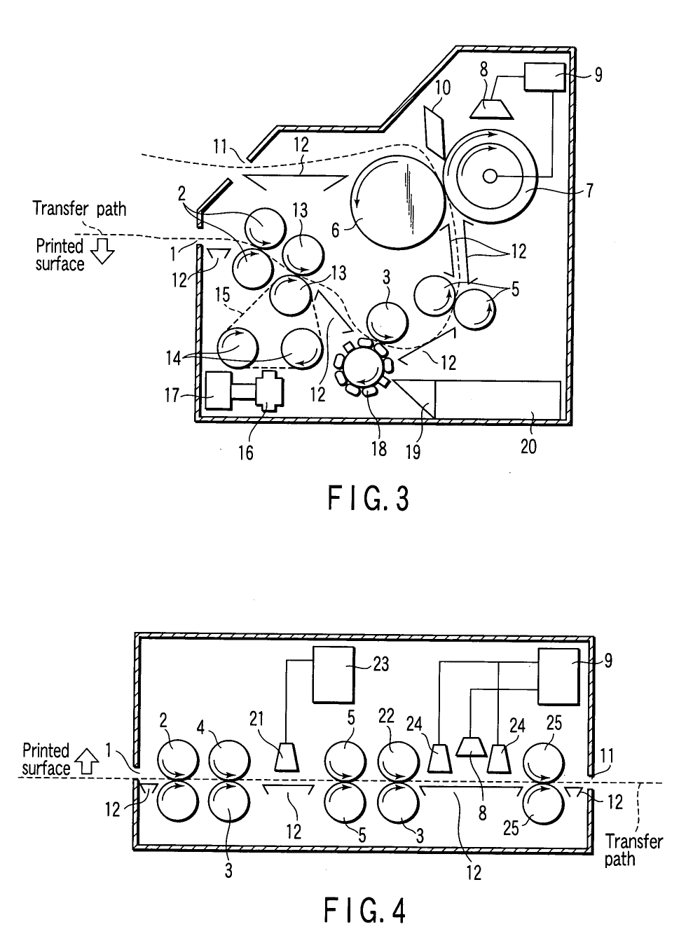

The apparatus according to the present example will be described with reference to FIG. 3. The first transfer rolls 2 are similar to those used in Example 1. The pair of rolls 13 is located immediately after the first transfer rolls 2. The stainless mesh sheet 15 is passed around one of the rolls 13 and the sheet transfer mechanism 14 moves the stainless mesh sheet 15 at a speed higher than that at which paper is transferred. The stainless mesh sheet 15 and the printed medium are driven at a relative speed of 30 mm/sec. The printed surface of the printed medium has polished by the stainless mesh sheet 15 by which most image forming material is peeled off. The suction type cleaning device 16 installed in a transfer path for the stainless mesh sheet 15 removes the waste of the image forming material, paper fibers, and the like which blocks the meshes, from the stainless mesh sheet 15. The waste material is collected in the disposable waste collection bag 17 provided inside the suction type cleaning device. Upon becoming full of the waste material, the disposable waste collection bag 17 is disposed of.

The brush roll 18 is installed immediately after the stainless mesh sheet 15 to softly rub the printed medium to brush off foreign matter from the surface. The brush roll 18 is provided with the blade 19 that cleans the roll 18 and the garbage can 20 that temporarily stores waste materials.

The pair of second transfer rolls 5 is installed at an appropriate distance from the brush roll 18. The transfer speed of the second transfer rolls 5 is set slightly higher than that of the first transfer rolls.

The heat roll 7 paired with the opposite roll 6 is placed immediately after the second transfer rolls 5. The adjustment of the temperature is similar to that in Example 1, so that its description is omitted here.

### EXAMPLE 3

The apparatus according to the present example uses two scratching rolls as a scratching mechanism and an infrared heater as a heater. The following are provided between the two scratching rolls: an optical sensor that senses the optical reflection density of the surface of the printed medium and a control device that controls the speed of the second scratching roll on the basis of an output from the optical sensor.

The apparatus according to the present example will be described with reference to FIG. 4. The components located before the first scratching roll 2 are similar to those of the first embodiment. The optical sensor 21 is provided immediately after the first scratching roll 2 to sense how the printed surface of the printed medium is polished. The control device 23 that operates as described below is also provided. The optical sensor 21 and the device 23 detects the difference in reflection density between the image portion and the printed medium itself after scratching or the reflection density of the image portion after the scratching. The device 23 sets a threshold value, for example, at 0.15 for the former case and at 0.25 for the latter case; Then, the device 23 controls driving conditions for the second scratching roll 22 installed immediately after the optical sensor, as described below. If the reflection density is higher than the threshold value, the device 23 raises the speed of the second scratching roll 22. If the reflection density is lower than the threshold value, the device 23 lowers the speed of the second scratching roll 22.

The second transfer rolls are similar to those described in Example 1, so that its description is omitted here. The infrared heater 24 located immediately after the second transfer rollers 5 heats the surface of the printed medium in a non-contact manner. As in the case of Example 1, the non-contact temperature sensor 8 detects the temperature of the printed medium. The temperature controller 9 then controls the actual temperature of the printed medium. The pair of discharge rollers 25 discharges the printed medium out of the apparatus.

### EXAMPLE 4

The apparatus according to the present example uses a scratching roll as a scratching mechanism and a heat roll as a heater. A roughening mechanism is provided after the heater to roughen the surface of the printed medium.

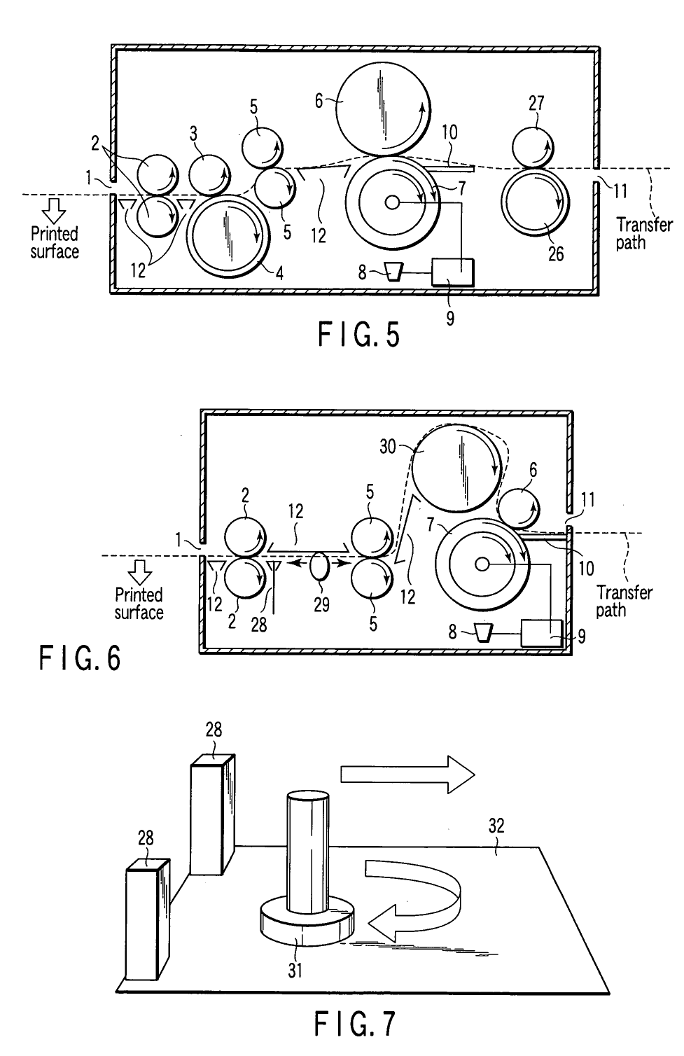

The apparatus according to the present example will be described with reference to FIG. 5. The components located before the heat roll 7 are similar to those of the first embodiment, so that their description is omitted here. The roughening roll 26 and the opposite roll 27 is provided immediately after the heat roll 7 to process an image decolorized surface of the printed medium to specified roughness. In the present example, the roughening roll 26 has surface roughness of #240. The roughening roll 26 and the printed medium are driven at a relative speed of 10 mm/sec. This reduces the degree of reflection that may occur on the surface of the printed medium polished by the scratching roll 4 of #400. The mental impression of the image after the decoloring is thus improved. In the present embodiment, the roughening roll 26 is not heated. However, the temperature of the roughening roll 26 may be set at a temperature higher than the softening temperature of the image forming material. This serves to minimize the adverse effect of a small amount of residues.

### EXAMPLE 5

The apparatus according to the present example uses a scratching bar as a scratching mechanism and a heat roll as a heater. In this apparatus, the printed medium is fixed during the scratching step. A scratching bar moves to scratch the surface of the printed medium.

The printed medium is transferred, at a fixed speed, by the first transfer rolls 2, installed close to the input port 1. The leading end of the printed medium is then sandwiched between the second transfer rollers 5. At this time, the fixing member 28 is used to nip and fix the printed medium. The first transfer rolls 2 are stopped, while the second transfer rolls 5 keep on rotating to tension the printed medium. Then, the scratching bar 29 moves between the first fixing member 28 and the second transfer rollers 5, while the printed medium is pressed against the transfer guide 12. The printed surface of the printed medium is thus scratched. The printed surface of the printed medium is polished by the reciprocation of the scratching bar 29. Thus, most image forming material is peeled off.

After the scratching step based on the reciprocation of the scratching bar 29 has been finished, the printed medium is transferred by a distance equal to the stroke of the scratching bar. The printed medium is then fixed again to undergo a scratching step. This step is repeated until the printed medium passes through the first transfer rolls 2.

The third transfer roll 30 is installed between the second transfer rolls 5 and the heat roll 7. The third transfer roll 30 is installed to increase the distance by which the printed medium is transferred to separate the printed medium from the heat roll 7. This prevents the printed medium from being heated by the heat roller 7 while being scratched; if this happens, the printed medium may be overheated. The components located after the heat roll 7 are similar to those of the first embodiment, so that their description is omitted here.

### EXAMPLE 6

The apparatus according to the present example will be described with reference to FIG. 7. In Example 5, the scratching mechanism is a reciprocating member. In contrast, in the apparatus according to the present example, the scratching mechanism 31 is a rotor having an axis in the direction of the perpendicular to the paper sheet 32. The scratching mechanism 31 moves in the direction of the face of the paper sheet 32. Alternatively, a plurality of similar rotors may be allowed to sweep the surface of the paper to improve decoloring quality. Similarly, the heater operated after scratching may be composed of a rotor having an axis in the direction of the perpendicular to the paper sheet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image decoloring apparatus decolorizing an image formed on a printed medium using a decolorable image forming material containing a color former, a developer, and a binder resin, comprising:
a scratching mechanism scratching the printed medium at a temperature lower than a softening temperature of the binder resin; and
a heater heating a scratched surface of the printed medium to a temperature higher than the softening temperature of the binder resin.

2. The apparatus according to claim 1, further comprising a transfer roll transferring the printing medium.

3. The apparatus according to claim 1, wherein the scratching mechanism is a scratching roll.

4. The apparatus according to claim 1, wherein the scratching mechanism is a mesh sheet moved by a roll.

5. The apparatus according to claim 1, wherein the scratching mechanism is a scratching bar.

6. The apparatus according to claim 1, wherein the heater is a heat roll.

7. The apparatus according to claim 1, wherein the heater is an infrared heater.

8. The apparatus according to claim 1, further comprising a cleaner cleaning the surface of the printed medium between the scratching mechanism and the heater.

9. The apparatus according to claim 8, wherein the cleaner is a brush roll.

10. The apparatus according to claim 1, further comprising:
a detector detecting a difference in reflection density between an image portion and the printed medium after scratching or a reflection density of the image portion after scratching; and
a controller controlling scratching conditions for the scratching mechanism.

11. The apparatus according to claim 1, wherein the detector is an optical sensor.

12. The apparatus according to claim 1, wherein the controller controls the speed of the scratching mechanism.

13. The apparatus according to claim 1, further comprising a roughening mechanism roughening a printed surface of the printed medium after the heater.
